(19) United States
(12) Patent Application Publication
(10) Pub. No.: US 2023/0259113 A1
(43) Pub. Date: Aug. 17, 2023

(54) SUBSYSTEM-LEVEL MODEL-BASED DIAGNOSIS

(71) Applicant: Novity, Inc., San Carlos, CA (US)

(72) Inventors: Ion Matei, Mountain View, CA (US); Alexandre Campos Perez, San Mateo, CA (US); Johan de Kleer, Los Altos, CA (US)

(73) Assignee: Novity, Inc., Palo Alto, CA (US)

(21) Appl. No.: 17/670,057

(22) Filed: Feb. 11, 2022

(51) Int. Cl. G05B 23/02

(52) U.S. Cl. CPC G05B 23/0259

(57) ABSTRACT

One embodiment provides a method and a system for diagnosing faults in a physical system. During operation, the system can obtain a model of the physical system comprising a plurality of components and can perform a structural analysis on the model to decompose the model into multiple independent subsystem models. A subsystem model corresponds to a subsystem comprising a subset of the plurality of components. The system can then perform, in parallel, a fault-diagnosis operation on each subsystem based on the corresponding subsystem model and can generate a diagnostic output indicating one or more components within the physical system being faulty based on outcomes of the fault-diagnosis operation on each subsystem.

### BACKGROUND

### Field

This disclosure is generally related to fault diagnosis of physical systems, such as machinery. More specifically, this disclosure is related to performing model-based diagnosis of a physical system by decomposing the system into a number of independent subsystems to make the diagnosis process more efficient.

### Related Art

Detection and diagnosis of faults in machinery are very important in many industries. For example, rotating machinery has found application in a wide variety of industries, such as aircraft, automobiles, farm equipment, industrial compressors, etc. Such machinery is often bulky and expensive, thus making it impractical to use redundant systems. Therefore, in-service, real-time monitoring and fault detection is needed.

There are two types of approach for fault diagnosis in machinery, including model-based diagnostic techniques and data-driven diagnostic techniques. In model-based approaches, a model of the machinery being diagnosed (i.e., the system) is provided to the diagnosis engine. Such a model can describe the behavior of the components based on their physical properties. Moreover, the diagnosis engine can receive values of the parameters of the model and some of the input and output values. The goal of the model-based diagnosis is to determine, from only the system model and available input/output values, whether a fault is present, and if so, the cause of the fault. This process can require a great amount of computation resources. On the other hand, data-driven approaches use statistical models (e.g., classifiers or regressors) trained with labeled data that describe the behavior of the system under different fault modes. This data-driven approach requires a large amount of data in order to build meaningful statistical models, and such a condition may not be easily satisfied. Moreover, the data-driven approaches often cannot provide sufficient information for explaining the detected system fault.

### SUMMARY

One embodiment provides a method and a system for diagnosing faults in a physical system. During operation, the system can obtain a model of the physical system comprising a plurality of components and can perform a structural analysis on the model to decompose the model into multiple independent subsystem models. A subsystem model corresponds to a subsystem comprising a subset of the plurality of components. The system can then perform, in parallel, a fault-diagnosis operation on each subsystem based on the corresponding subsystem model and can generate a diagnostic output indicating one or more components within the physical system being faulty based on outcomes of the fault-diagnosis operation on each subsystem.

In a variation on this embodiment, performing the fault-diagnosis operation can include estimating parameters of the subsystem model and determining a faulty parameter based on the estimated parameters and their corresponding loss functions.

In a further variation, determining the faulty parameter can further include computing, for each parameter, an empirical probability based on the loss functions; and determining a parameter with a maximum empirical probability as the faulty parameter.

In a variation on this embodiment, performing the structural analysis on the model can include performing a causal analysis of a plurality of equations associated with the model.

In a further variation, performing the causal analysis can include generating a block lower triangular (BLT) form of the plurality of equations.

In a variation on this embodiment, decomposing the model into multiple independent subsystem models can include identifying, for each subsystem model, a number of input variables.

In a further variation, the system installs one or more sensors corresponding to the identified input variables.

In a further variation, the system can obtain sensor measurement results associated with the identified input variables and can use the sensor measurement results as inputs of the subsystem model during the fault-diagnosis operation.

### BRIEF DESCRIPTION OF THE FIGURES

FIG. 1A presents a flowchart illustrating an exemplary process for model-based fault diagnosis, according to one embodiment.

FIG. 1B illustrates in more detail the diagnosis process, including the parallel performing of the parameter-estimation processes, according to one embodiment.

FIG. 2 illustrates a friction model.

FIG. 3 illustrates the block lower triangular (BLT) form of an exemplary system model.

FIG. 4A shows the amplified view of a portion of the matrix shown in FIG. 3.

FIG. 4B illustrates the decoupled brake-and-inertia subsystem, according to one embodiment.

FIG. 5 presents a table that compares the model complexity between the entire friction system and the brake-and-inertia subsystem, according to one embodiment.

FIG. 6A presents a flowchart illustrating an exemplary process for performing fault diagnosis by decomposing a system into multiple subsystems, according to one embodiment.

FIG. 6B and FIG. 6B-1 illustrate in more detail the diagnosis process, according to one embodiment.

FIG. 7 presents an exemplary apparatus for diagnosing faults in a physical system, according to one embodiment.

FIG. 8A and FIG. 8B illustrate an exemplary computer and communication system that facilitates diagnosing faults in physical systems, according to one embodiment.

In the figures, like reference numerals refer to the same figure elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown but is to be accorded the widest scope consistent with the principles and features disclosed herein.

### Overview

Embodiments described herein provide a solution for improving the time efficiency of model-based fault diagnosis of physical systems. A model-based diagnosis engine uses a parameter estimation technique to detect and isolate faults. More specifically, the system model of a to-be-diagnosed physical system can be decomposed into a number of subsystems that can be treated independently. During operation, the dependency of variables of a system model can be determined by generating the block lower triangular (BLT) form of the model equations and determining, based on the BLT form, one or more input variables for a subsystem. By performing measurements on the input variables and using the measurement results as input to the model, model equations corresponding to the subsystem can be treated as independent of the rest of the system model. Once the system model is decomposed into subsystems, the diagnosis engine can perform fault diagnosis in parallel for each fault parameter and for each subsystem, thus significantly increasing the time efficiency for fault diagnosis.

### Fundamentals of Model-Based Fault Diagnosis

Model-based fault diagnosis determines a fault by comparing deviations (of at least one characteristic property or parameter of the system) from nominal conditions in system-observable quantities. The diagnosis engine typically is provided with a model of the system, nominal values of the parameters of the model, and time series of inputs and outputs of the system. The main goal of a diagnosis engine is to detect a fault and to isolate it. There is a long history of model-based diagnosis methods proposed independently by the artificial intelligence (AI) and control communities.

The model-based diagnosis methods can be classified into three major categories: parameter estimation-based, observer-based, and redundancy relations (or parity equations)-based. For parameter estimation-based fault diagnosis, changes in the system parameters (e.g., stiffness or damping coefficients) can be tracked and detected. If a significant deviation is detected, an alarm can be raised. The parameter tracking can be performed by running optimization algorithms using time series of sensor measurements that learn the current parameter values, or filters (e.g., a Kalman filter, a particle filter), where the state vector is augmented to include system parameters. If the nominal values of the system parameters are known, state and output observers can be used, where deviations in the system behavior are treated as additive faults. There are several possible combinations of observers aimed at detecting single or multiple faults, such as an observer excited by one output, a bank of observers excited by all outputs, a bank of observers excited by single outputs, or a bank of observers excited by all outputs, except one. The redundant relations (or parity equations) diagnosis methods use part of the system model (constitutive equations) to derive residuals, and faults can be detected when the residual values are larger than some preset threshold. By tracking the residual sensitivity to system parameters or components, faults can be isolated as well. The parameter estimation and observer-based diagnosis methods require a fault model: deviation of parameters from their nominal value, additive or multiplicative faults. The redundancy relations-based methods do not require fault models; however, they typically require more sensors to disambiguate among multiple possible faults.

Model-based diagnosis requires accurate models of the physical systems to detect and isolate faults in the physical systems. For real-time diagnosis, such models need to be simulated within a maximum allotted time interval. Typically, the more accurate the models are, the more complex they become; hence, they will take more time to simulate. In addition, the type of mathematical model (e.g., ordinary differential equation (ODE) and differential algebraic equation (DAE)) and its dynamic response (e.g., stiff or non-stiff) can add to the time complexity of the simulation process. In particular, DAE simulations require the use of the Newton-Raphson algorithm that in turn requires the inversion of the system Jacobian matrix. The time complexity of such an operation is O(n³), where n is the number of equations. Therefore, model complexity is a deterrent for real-time implementations of model-based diagnosis algorithms.

The behavior of a physical system can be described by a DAE of the form:

0=F(\dot{x}, x, u), (1)

y=h(x, u), (2)

where x represents the state vector, u is the vector of inputs, and y is a vector of outputs. In this disclosure, parametric faults are considered. Parametric faults are faults that can be detected by detecting deviations of the system parameters from their nominal values. Parametric faults do not impose significant constraints on the type of faults that can be detected and isolated. Indeed, it has been shown that the physical model of a system can be augmented with fault modes inspired by the physics of failure. The physics-based fault augmentation process adds additional equations to the model. These new equations are dependent on parameters whose activation induces the simulated faulty behavior. The types of faults introduced are domain dependent. We can model faults in the electrical (e.g., short, open connections, parameter drifts, etc.), mechanical (e.g., broken flanges, stuck flanges, torque losses due to added friction, efficiency losses, etc.), or fluid (e.g., blocked pipes, leaking pipes, etc.) domains.

Using F={F₁, . . . , F_{M}} to denote the set of faults that need to be detected and isolated, where F₀ denotes the normal behavior, the diagnosis objective is to construct a classifier f:Y→{F₁, . . . , F_{M}}, where Y is a set of observations of the system behavior, typically given by a set of sensor measurements that are processed sample by sample or in batches. A set of fault parameters {θ₁ . . . , θ_{M}} can be associated with each of the fault modes with nominal values θ*ᵢ for i∈{1, . . . , M}. The classifier fault detection scheme is defined as a deviation of the output measurements from their expected values. The fault isolation can be done based on the deviation of the fault parameters from their nominal values, i.e., ∥θᵢ−θ*ᵢ∥≥εᵢ, where εᵢ is a fault-specific threshold that depends on measurement noise statistics.

Because estimating jointly all fault parameters can create ambiguity (combination of fault parameter values can generate outputs similar to a single parameter value), each fault parameter should be estimated separately. During the estimation of a single parameter, the remaining fault parameters are assumed to be nominal. The estimation of a fault parameter is done by solving a least-square optimization problem, over a fault time window T. During this window, time samples of inputs and outputs are used in an optimization problem whose solution is an estimate of the considered fault parameter. In particular, the optimization problem can have the following form:

$${min}_{{θ}_{i} ∈ {Θ}_{i}} L ( {θ}_{i} ) , \qquad ( 3 )$$

$$0 = F ( \dot{x} , x , u ; θ ) , \qquad ( 4 )$$

$${\hat{y}}_{j} = h ( x , u ; θ ) , \qquad ( 5 )$$

where L(θⱼ)=Lⱼ=Σᵢ₋₀^{N}∥y(tᵢ)−ŷⱼ(tᵢ)∥ is the least-square loss function, tᵢ are time samples in the interval [0,T], ŷⱼ is the output vector when the parameter θⱼ is varied while other parameters remain constant, y(tᵢ) are sensor measurements, and Θⱼ is a constraint set for the parameter θⱼ. The optimization problems for multiple parameters can be solved in parallel, and the diagnosis solution can be decided based on a maximum likelihood argument. In particular, one can define empirical probabilities as

$${w}_{i} = \frac{1 / {L}_{i}}{{\sum }_{j} 1 / {L}_{j}} ,$$

and the fault is selected using i*=max arg{wᵢ}.

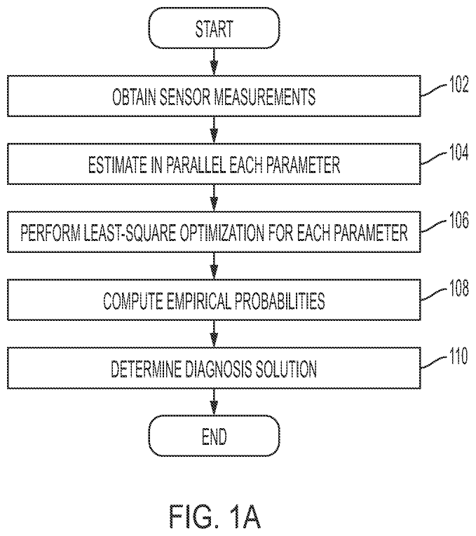

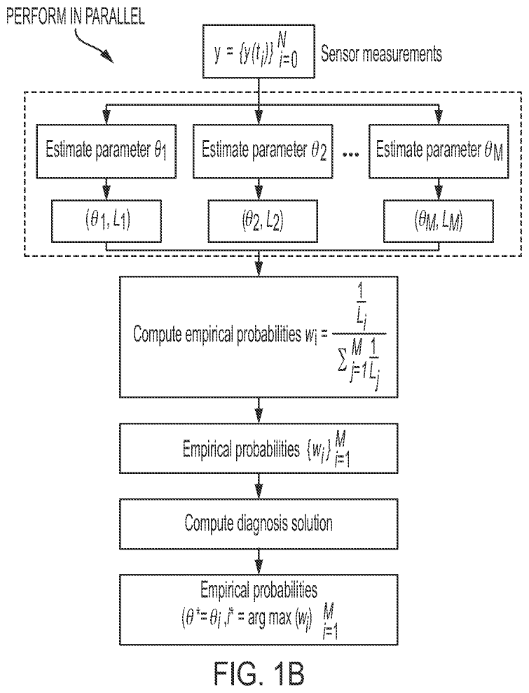

FIG. 1A illustrates an exemplary process for model-based fault diagnosis, according to one embodiment of the instant application. During operation, time series of sensor measurements (y={y(tᵢ)}ᵢ₌₀^{N}) can be obtained (operation 102). Based on the sensor measurements, parameter estimation can be performed for each parameter (i.e., vary one parameter while the others remain constant) in parallel (operation 104), and the least-square optimization of each parameter can also be performed in parallel (operation 106). Subsequent to the optimization, the empirical probabilities of all parameters ({wᵢ}ᵢ₌₁^{M}) can be computed using the optimal cost values of each parameter (operation 108). The diagnosis solution can then be determined based on the empirical probabilities of all parameters (operation 110). The diagnosis solution is the most likely fault parameter, as per the empirical probability distribution. FIG. 1B illustrates in more detail the diagnosis process, including the parallel performing of the parameter-estimation processes, according to one embodiment.

Each optimization problem uses a model of the system to simulate the system outputs. The DAE representing the system model may include artifacts (discrete terms and discontinuities) that make it inappropriate for use with solvers featuring automatic differentiation. In such a case, gradient-free algorithms can be used, but they are typically slower. While the parallelism in testing for each of the fault parameters does help with the time efficiency, the model complexity can take its toll on each optimization problem.

### System Decomposition

To reduce the time complexity, in some embodiments, the to-be-simulated physical system can be divided into multiple subsystems, such that when a fault parameter is estimated, one only needs to perform simulation on the corresponding subsystem.

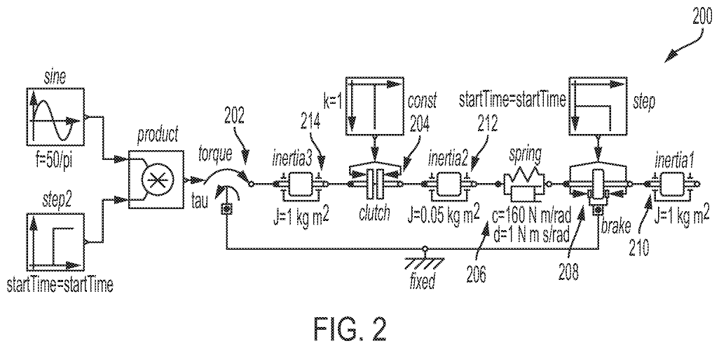

To explain the method and process of decomposing a physical system, the following description uses a friction model as an example. FIG. 2 illustrates a friction model. As shown in FIG. 2, friction model 200 can emulate a simplified drive train exhibiting the presence of an engine (torque source component 202), a clutch 204, a flexible shaft (e.g., a spring-damper component 206), and a brake 208, with corresponding inertia components (e.g., inertia components 210, 212, and 214). The outputs of friction model 200 are the torques of clutch 204, spring-damper 206, and brake 208, while the inputs of friction model 200 are the engine torque, and the clutch and brake signals that control activation/deactivation of these components.

To increase the timing efficiency of the simulation, a physical system (which can have a large number of components) can be decomposed into a number of smaller subsystems (with each subsystem comprising a smaller number of components). For example, the system shown in FIG. 2 can be decomposed into several subsystems, with at least a subsystem including clutch 204 and a subsystem including brake 208. Simulating the behavior of the physical system can be done by simulating the behaviors of these smaller subsystems in parallel. Because the subsystem models have a reduced size and are less complex, the amount of time needed for simulating each subsystem can be much less than the time needed for simulating the entire physical system, thus significantly increasing the time efficiency.

As discussed previously, the behavior of a physical system (e.g., the drive train represented by friction model 200) can be described by a number of equations. Decomposing a system into multiple subsystems can involve grouping these equations into multiple groups, with each group of equations describing a corresponding subsystem. Ideally, the subsystems are independent of each other (meaning that solving equations in one subsystem does not rely on values of variables in other subsystems) to allow simulations of the subsystems to be performed in parallel. However, for a typical physical system, the equations are often dependent upon each other, meaning that solving the equations in one subsystem may rely on variable values obtained by solving one or more equations in a different subsystem. The dependency relationship among subsystems makes it difficult to perform simulations in parallel.

To decouple the subsystems, in some embodiments, sensor measurements can be used as inputs for the subsystems. More specifically, the behavior of each subsystem can be described by a set of equations that contain, in addition to unknown, to-be-solved variables, a set of “input” variables. These “input” variables are quantities that are computed by solving equations at other parts of the model (or other subsystems). However, instead of solving those equations, values of the “input” variables can be obtained by performing sensor measurements. This way, simulation of this particular subsystem no longer depends on simulation results of the other subsystem, making parallel simulation of the subsystems possible.

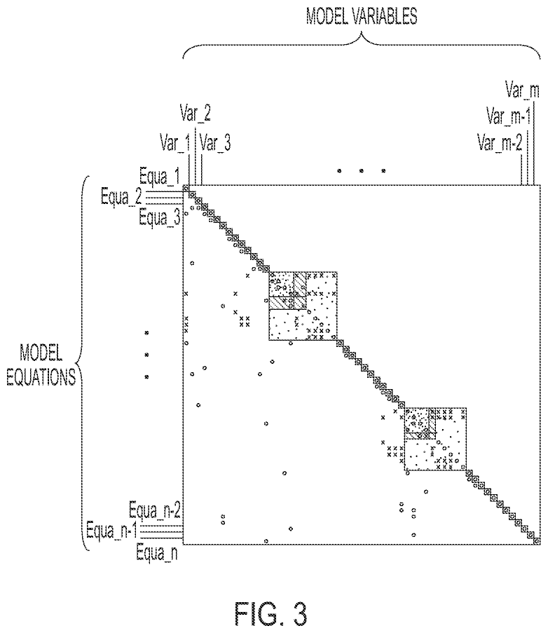

In some embodiments, the dependency among the model variables can be determined by generating the block lower triangular (BLT) form of the system model, which allows the system of equations to be solved by block forward substitution. FIG. 3 illustrates the block lower triangular (BLT) form of an exemplary system model. More specifically, the row indices of the matrix represent coefficients of the model equations (e.g., Equa_1, Equa_2, . . . , Equa_n) and the column indices of the matrix represent the model variables (e.g., Var_1, Var_2, . . . , Var_m). In this example, the matrix is sparse (meaning that it is comprised of mostly zero values). However, non-zero elements at non-diagonal locations indicate dependency between equations (or between subsystems).

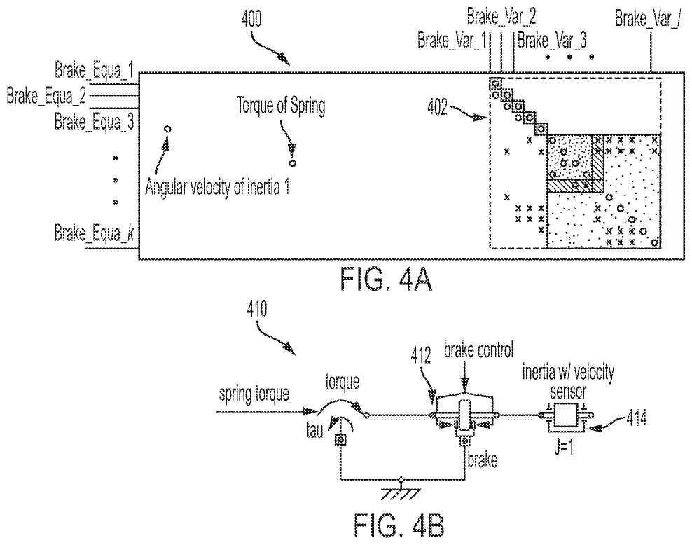

FIG. 4A shows the amplified view of a portion of the matrix shown in FIG. 3. More specifically, FIG. 4A focuses on a subsystem comprising the brake and its following inertia component, referred to as a brake-and-inertia subsystem. In FIG. 4A, section 400 corresponds to a set of equations (e.g., Brake_Equa_1, Brake_Equa_2, . . . , Brake_Equa_k) that describe the behaviors of the brake and its following inertia component (brake 208 and inertia component 210 shown in FIG. 2).

From FIG. 4A, one can see that solving the equations included in section 400 relies on values of two variables (i.e., the angular velocity of inertia and the torque of spring) that can be obtained by solving other equations. In other words, these two variables couple the brake-and-inertia subsystem to other parts of the entire friction system. If the values of these two variables can be obtained through sensor measurements (instead of by solving other equations), then the brake-and-inertia subsystem can be decoupled or separated from other parts of the model of the entire friction system. In FIG. 4A, dashed box 402 indicates the decoupled brake-and-inertia subsystem that includes a set of equations (e.g., Brake_Equa_1, Brake_Equa_2, . . . , Brake_Equa_k) and a set of solvable variables (e.g., Brake_Var_1, Brake_Var_2, . . . , Brake_Var_l). In addition, the decoupled brake-and-inertia system includes two input variables (i.e., the angular velocity of inertia and the torque of spring) whose values are obtained through sensor measurements.

FIG. 4B illustrates the decoupled brake-and-inertia subsystem, according to one embodiment. In FIG. 4B, brake-and-inertia subsystem 410 can include brake component 412 and an inertia component 414. Inertia component 414 can include a sensor for measuring its angular velocity. Inputs to brake-and-inertia subsystem 410 can include the brake control (which is part of the input of the entire friction system), the spring torque (which is obtained by a sensor installed on spring component 206 shown in FIG. 2), and the angular velocity of inertia component 414 (which is obtained by the sensor on inertia component 414). Because brake-and-inertia subsystem 410 is independent of other parts of the entire friction system, to diagnose brake faults, one only needs to run a simulation of brake-and-inertia subsystem 410.

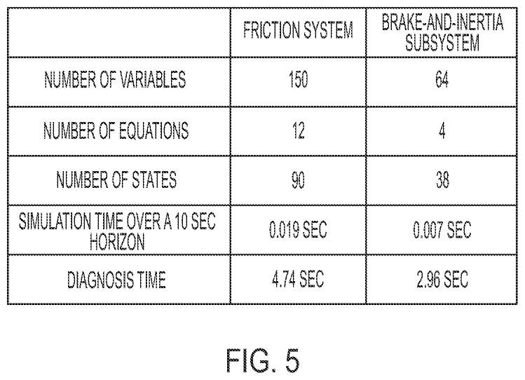

FIG. 5 presents a table that compares the model complexity between the entire friction system and the brake-and-inertia subsystem, according to one embodiment. More specifically, the entire friction system can be similar to system 200 shown in FIG. 2 and the brake-and-inertia subsystem 410 shown in FIG. 4B; the BLT form of the model of the entire friction system can be similar to what is shown in FIG. 3, and the BLT form of the model of the brake-and-inertia subsystem can be similar to the subsystem model included in dashed box 402.

Compared with the entire friction system, the brake-and-inertia subsystem has fewer variables, fewer equations, and fewer states. Consequently, the amount of time needed for simulation (e.g., for simulating a predetermined time horizon) of the subsystem can be much less than what is needed for simulation of the entire system. Because parameter estimation-based fault diagnosis depends on how fast the models can be simulated, simpler models can result in faster diagnosis. In the example shown in FIG. 5, simulation of the subsystem model can be twice as fast as the simulation of the model of the entire system; accordingly, the time needed for brake-fault diagnosis can be reduced by half.

In addition to increasing the time efficiency for diagnosing a particular subsystem, decoupling subsystems can also increase the time efficiency for diagnosing the entire system. More specifically, the entire system can be divided into a number of independent subsystems, and fault diagnosis can be performed in parallel for each subsystem. This way, the amount of time needed for diagnosing faults in the entire system can be the amount of time needed for diagnosing the most complex subsystem. Using friction system 200 shown in FIG. 2 as an example, a subsystem comprising clutch component 204 may be more complex (e.g., including more equations and more variables) than the brake-and-inertia subsystem. Hence, the amount of time needed for diagnosing the entire system may be limited by the time needed for diagnosing the clutch subsystem. Even with this limitation, the total amount of time needed for diagnosing the entire system can still be less than performing system diagnosis using the model of the entire system.

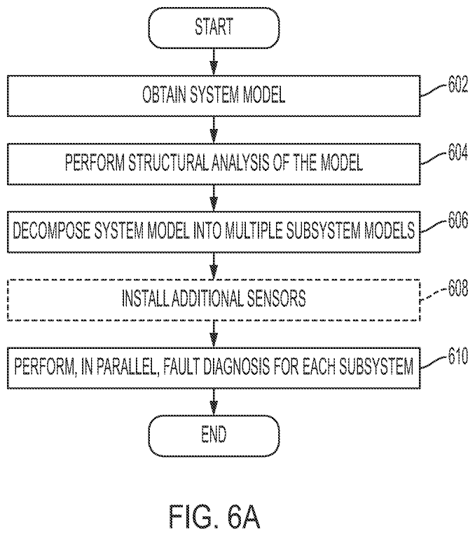

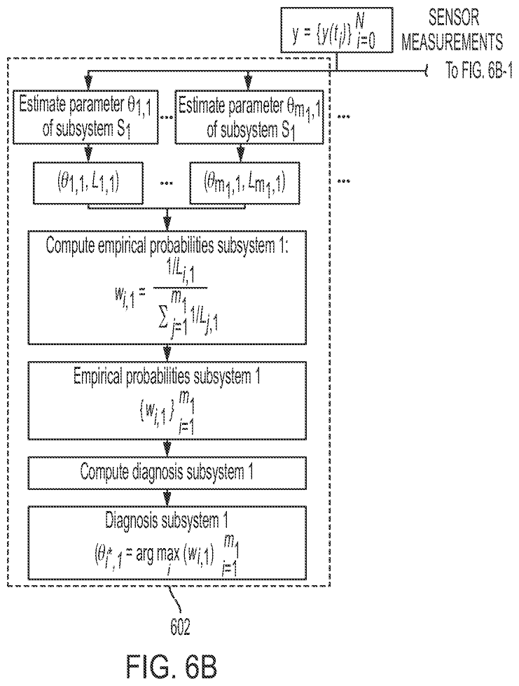

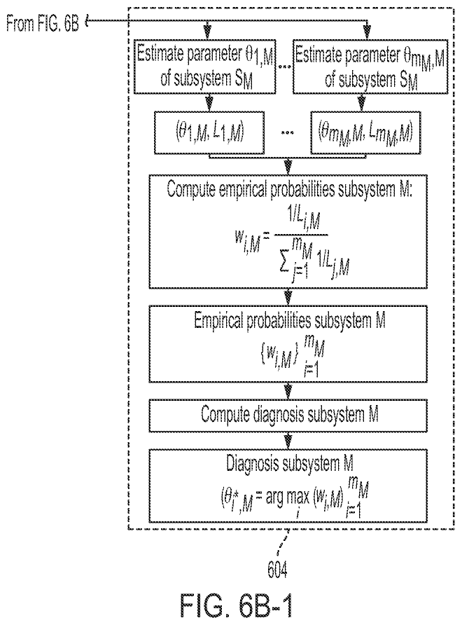

FIG. 6A presents a flowchart illustrating an exemplary process for performing fault diagnosis by decomposing a system into multiple subsystems, according to one embodiment. During operation, the diagnosis engine receives a model of a physical system (operation 602). The physical system can include a mechanical system, an electrical system, a hydraulic system, or a combination thereof. The system model can be obtained from the designer or manufacturer of the physical system or can be developed based on knowledge of individual components within the system.

Based on the system model, the diagnosis engine can perform structural analysis of the system (operation 604). For example, the diagnosis engine can perform causal analysis of the model equations to derive causal relationships among the model equations. Note that equations without a causal relationship are probably independent of each other. In some embodiments, to execute the causal analysis, the diagnosis engine can generate a BLT form of the system model. Existing tools or known techniques (e.g., using the graph theory to associate model variables with model equations) can be used to generate the BLT form of the system model. The scope of this disclosure is not limited by the techniques used to generate the BLT form.

The diagnosis engine can subsequently decompose the model of the physical system into multiple independent subsystem models (operation 606). In some embodiments, the diagnosis engine can use output of the structural analysis (e.g., the causal relationship among model equations or the BLT form of the model) to determine one or more subsystem models that are independent of other parts of the system model. When determining that a subsystem model is independent, the diagnosis engine can identify a number of “input” variables for that subsystem model and determine whether sensor measurements of their values can be obtained. Such input variables are variables that couple the subsystem model to other parts of the system model. Note that it is possible that a subsystem model is naturally independent, meaning that it does not have any input variables. Obtaining sensor measurements of the input variables can “decouple” the subsystem model from the other parts of the system model. In certain situations, sensor measurements of certain input variables may not be readily available. For example, if inertia component 414 shown in FIG. 4B is not equipped with a velocity sensor, sensor measurements of the angular velocity of inertia component 414 cannot be obtained. In such a case, brake-and-inertia subsystem 410 remains dependent on other parts of the system model (e.g., the equations that can provide values of the angular velocity). To solve this issue, before running the diagnosis, one may install the additional sensors required for decoupling the subsystems (optional operation 608). In addition, knowledge of the input variables of each subsystem can be useful in the design stage of the physical system. By including predetermined types of sensors at predetermined locations, one can ensure that the physical system can be successfully decomposed into multiple independent subsystems for purposes of faster fault diagnosis.

Once the physical system is decomposed into multiple subsystems, the fault-diagnosis process can be performed in parallel for each subsystem (operation 610). Note that the process for performing fault diagnosis for each subsystem can be similar to what is shown in FIGS. 1A-1B, except that additional sensor measurements associated with the input variables are needed for each subsystem. Because each subsystem model is less complex than the full system model, the amount of time needed for diagnosing each subsystem can be much smaller than diagnosis based on the full system model. The diagnosis output of the entire physical system can be the combined diagnosis outputs of the subsystems.

FIG. 6B illustrates in more detail the diagnosis process, according to one embodiment. More specifically, FIG. 6B illustrates that after obtaining the sensor measurements, the diagnosis engine can perform, in parallel, fault diagnosis operations for each subsystem. In FIG. 6B, the parallel fault diagnosis process for each subsystem is included in a dashed box, such as boxes 602 and 604. In this example, there are M subsystems, including subsystems S₁, S₂, . . . , and S_{M}. Note that the sensor measurements (y={y(tᵢ)}ᵢ₌₀^{N}) not only include the observations of the behaviors of the entire system but also include measurement results of input variables for each subsystem.

The fault diagnosis process included in each dashed box can be similar to the process shown in FIG. 1B, as applied to each subsystem. More specifically, based on the model of each subsystem and outputs of the sensors associated with the subsystem, the diagnosis engine can estimate the parameters of each subsystem. In the example shown in FIG. 6B, each subsystem j has mⱼ fault parameters. Similar to what is shown in FIG. 1B, the estimation of each parameter (which can involve performing nonlinear least-square optimization for the parameter) can be performed in parallel for the mⱼ fault parameters in each subsystem. Compared with the entire system mode, the subsystem model can be smaller and less complex, thus resulting in a faster parameter estimation process.

The diagnosis engine can subsequently compute, for each subsystem, the empirical probability distribution of the fault parameters within the subsystem, and the diagnosis solution is the most likely faulty parameter, per the empirical probability distribution. Accordingly, the component associated with the faulty parameter will be identified as the faulty component. Because the subsystems are independent of each other, the diagnosis solutions of the subsystems are also independent of each other. In other words, multiple faulty components may be identified.

In the examples shown in FIG. 6B, the physical system is decomposed into multiple independent subsystems, and simulations of the subsystems can run in parallel to increase time efficiency. In some embodiments, it is also possible to further decompose a subsystem into a number of smaller blocks to allow parallel simulation of the smaller blocks. In further embodiments, the smaller blocks may include a precursor block, meaning that all other blocks depend on the precursor block. Sensor measurements of variables in the precursor block cannot be obtained; values of those variables can only be obtained by solving the model equations. Once equations in the precursor block are solved, all other blocks in the subsystem can become independent, thus allowing parallel simulations of those other blocks. This approach can be used in situations where sensor measurements of certain input variables are unavailable.

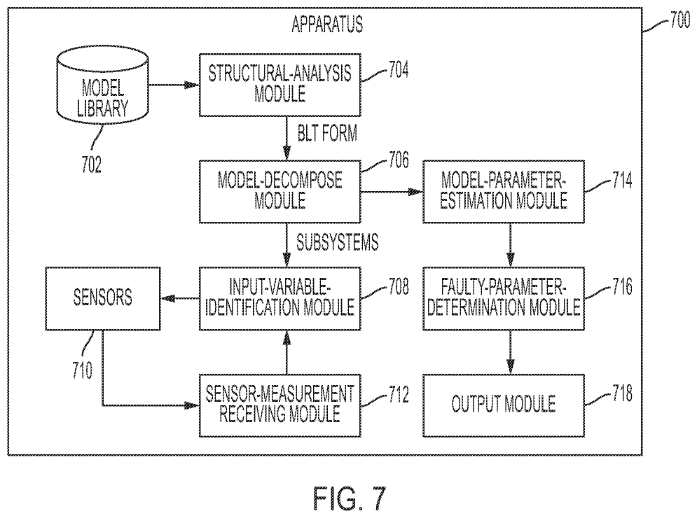

FIG. 7 presents an exemplary apparatus for diagnosing faults in a physical system, according to one embodiment. Apparatus 700 includes a model library 702, a model-structural-analysis module 704, a model-decomposing module 706, an input-variable-identification module 708, a number of sensors 710, a sensor-measurement-receiving module 712, a model-parameter-estimation module 714, a faulty-parameter-determination module 716, and an output module 718.

Model library 702 stores a number of models of to-be-diagnosed physical systems. A model can be a set of mathematical equations that describe behaviors of components in the corresponding physical system. Model-structural-analysis module 704 can be responsible for performing structural analysis of the model of a to-be-diagnosed system. In some embodiments, performing the structural analysis can include analyzing causal relationships among the model equations. In further embodiments, to execute the causal analysis, the BLT form of the system model can be generated.

Model-decomposing module 706 can be responsible for decomposing the model of the entire physical system into multiple subsystem models based on the outcome of the structural analysis (e.g., the BLT form of the model). Model equations having a stronger causal relationship can be grouped together to form a subsystem model. For each subsystem, input-variable-identification module 708 can identify a number of input variables as additional inputs of the subsystem model to enable independence of the subsystem model. The subsystem model can become independent of other parts of the system model (i.e., other equations) by obtaining (e.g., through sensor measurement) values of the identified input variables.

Sensors 710 can include sensors for observing behaviors of the system (e.g., measuring outputs of the system model) and sensors for measuring values of the input variables of each subsystem. Sensor-measurement-receiving module 712 can receive, from each sensor, the measurement result, which can be within a predetermined time window.

Model-parameter-estimation module 714 can be responsible for estimating time parameters for each subsystem. The parameter estimation process can be done by solving a least-square optimization problem, and the optimization can be performed in parallel for each parameter within each subsystem. Because the subsystems are independent, when a parameter is estimated, only the corresponding subsystem model needs to be simulated. Simulating the smaller subsystem model can be much faster than simulating the model of the entire system.

Faulty-parameter-determination module 716 can be responsible for determining, for each subsystem, the most likely fault parameter. More specifically, faulty-parameter-determination module 716 can compute, for each parameter within each subsystem, the empirical probability and determine that the parameter with the maximum empirical probability is the faulty parameter. Output module 718 can be responsible for outputting the diagnosis solution for each subsystem. The diagnosis solution can be the faulty parameter and/or the component associated with the faulty parameter.

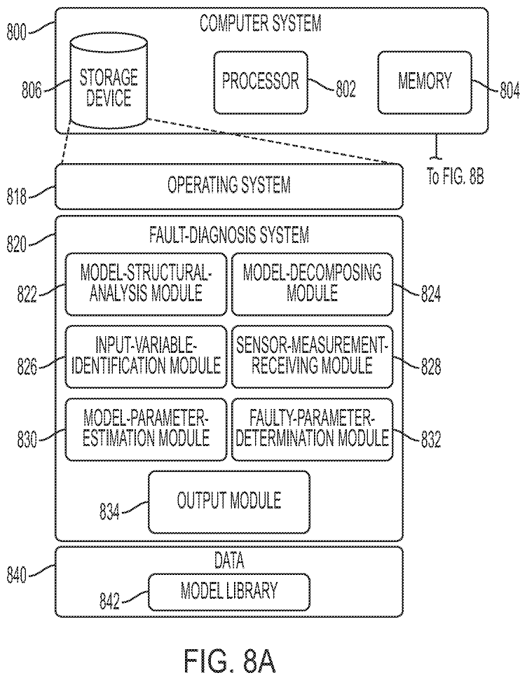

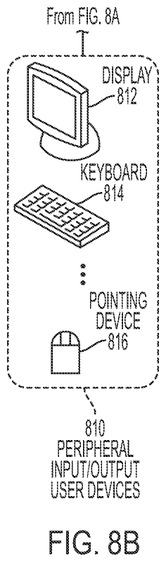

FIG. 8 illustrates an exemplary computer and communication system that facilitates diagnosing faults in physical systems, according to one embodiment. Computer system 800 includes a processor 802, a memory 804, and a storage device 806. Furthermore, computer system 800 can be coupled to peripheral input/output (I/O) user devices 810, e.g., a display device 812, a keyboard 814, and a pointing device 816. Storage device 806 can store an operating system 818, a fault-diagnosis system 820, and data 840.

Fault-diagnosis system 820 can include instructions, which when executed by computer system 800, can cause computer system 800 or processor 802 to perform methods and/or processes described in this disclosure. Specifically, fault-diagnosis system 820 can include instructions for performing structural analysis on a model of a physical system (model-structural-analysis module 822), instructions for decomposing the system model into multiple subsystem models (model-decomposing module 824), instructions for identifying input variables for each subsystem model (input-variable-identification module 826), instructions for receiving sensor measurements (sensor-measurement-receiving module 828), instructions for estimating parameters for each subsystem model (model-parameter-estimation module 830), and instructions for determining the most likely faulty parameter in each subsystem (faulty-parameter-determination module 832). Data 840 can include a model library 842.

In general, the disclosed embodiments provide a system and method for improving the time efficiency of fault diagnosis of a physical system using the parameter-estimation-based diagnosis technique. More specifically, the model of a to-be-diagnosed physical system can be analyzed and decomposed into multiple smaller subsystem models, with each subsystem model modeling the behavior of a subset of components of the original physical system. To enable decoupling between the subsystem models, the diagnosis engine can identify, for each subsystem, a number of input variables, which are variables that couple a subsystem model to other parts of the system model (i.e., other subsystem models). The decoupling can be achieved by treating these input variables as inputs to the subsystem model (instead of as to-be-solved model variables) and by obtaining their values using sensors (instead of solving model equations). Fault diagnosis operations on the decoupled or independent subsystems can be performed in parallel, thus increasing the time efficiency. In situations where sensors for measuring values of the input variables are not installed, appropriate types of sensors can be installed at desired locations to collect data for diagnostic purposes. In some embodiments, the diagnosis process may include a combination of serial and parallel operations, where a precursor block within a subsystem needs to be simulated first to allow other blocks within the subsystem to be simulated in parallel. This disclosure uses a mechanical system (e.g., a drive train comprising an engine, a clutch, a brake, and multiple inertia components) as an example to explain the principle of operation of the diagnosis engine. In practice, the same technique can be used to diagnose different types of physical systems, including but not limited to: mechanical systems, electrical systems, hydraulic systems, and a combination thereof. Moreover, in addition to the parameter-based diagnosis techniques, other types of model-based diagnosis techniques, including observer-based techniques and redundancy relations (or parity equations)-based techniques, can also benefit from the approach of decomposing a large system model into multiple smaller subsystem models.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for diagnosing faults in a physical system, the method comprising:
obtaining, by a computer, a model of the physical system comprising a plurality of components;
performing a structural analysis on the model to decompose the model into multiple independent subsystem models, wherein a subsystem model corresponds to a subsystem comprising a subset of the plurality of components;
performing, in parallel, a fault-diagnosis operation on each subsystem based on the corresponding subsystem model; and
generating a diagnostic output indicating one or more components within the physical system being faulty based on outcome of the fault-diagnosis operation on each subsystem.

2. The method of claim 1, wherein performing the fault-diagnosis operation comprises:
estimating parameters of the subsystem model; and
determining a faulty parameter based on the estimated parameters and their corresponding loss functions.

3. The method of claim 1, wherein performing the structural analysis on the model comprises performing a causal analysis of a plurality of equations associated with the model.

4. The method of claim 3, wherein performing the causal analysis comprises generating a block lower triangular (BLT) form of the plurality of equations.

5. The method of claim 1, wherein decomposing the model into multiple independent subsystem models comprises identifying, for each subsystem model, a number of input variables.

6. The method of claim 5, further comprising installing one or more sensors corresponding to the identified input variables.

7. The method of claim 5, further comprising:
obtaining sensor measurement results associated with the identified input variables; and
using the sensor measurement results as inputs of the subsystem model during the fault-diagnosis operation.

8. A non-transitory computer-readable storage medium storing instructions that when executed by a computer cause the computer to perform a method for generating test vectors for a computational system, the method comprising:
obtaining, by a computer, a model of the physical system comprising a plurality of components;
performing a structural analysis on the model to decompose the model into multiple independent subsystem models, wherein a subsystem model corresponds to a subsystem comprising a subset of the plurality of components;
performing, in parallel, a fault-diagnosis operation on each subsystem based on the corresponding subsystem model; and
generating a diagnostic output indicating one or more components within the physical system being faulty based on outcome of the fault-diagnosis operation on each subsystem.

9. The non-transitory computer-readable storage medium of claim 8, wherein performing the fault-diagnosis operation comprises:
estimating parameters of the subsystem model; and
determining a faulty parameter based on the estimated parameters and their corresponding loss functions.

10. The non-transitory computer-readable storage medium of claim 8, wherein performing the structural analysis on the model comprises performing a causal analysis of a plurality of equations associated with the model.

11. The non-transitory computer-readable storage medium of claim 10, wherein performing the causal analysis comprises generating a block lower triangular (BLT) form of the plurality of equations.

12. The non-transitory computer-readable storage medium of claim 8, wherein decomposing the model into multiple independent subsystem models comprises identifying, for each subsystem model, a number of input variables.

13. The non-transitory computer-readable storage medium of claim 12, wherein the method further comprises:
obtaining sensor measurement results associated with the identified input variables; and
using the sensor measurement results as inputs of the subsystem model during the fault-diagnosis operation.

14. A computer system for diagnosing faults in a physical system, the computer system comprising:
a processor; and
a storage device coupled to the processor and storing instructions, which when executed by the processor cause the processor to perform a method, the method comprising:
obtaining, by a computer, a model of the physical system comprising a plurality of components;
performing a structural analysis on the model to decompose the model into multiple independent subsystem models, wherein a subsystem model corresponds to a subsystem comprising a subset of the plurality of components;
performing, in parallel, a fault-diagnosis operation on each subsystem based on the corresponding subsystem model; and
generating a diagnostic output indicating one or more components within the physical system being faulty based on outcome of the fault-diagnosis operation on each subsystem.

15. The computer system of claim 14, wherein performing the fault-diagnosis operation comprises:
estimating parameters of the subsystem model; and
determining a faulty parameter based on the estimated parameters and their corresponding loss functions.

16. The computer system of claim 15, wherein determining the faulty parameter further comprises:
computing, for each parameter, an empirical probability based on the loss functions; and
determining a parameter with a maximum empirical probability as the faulty parameter.

17. The computer system of claim 14, wherein performing the structural analysis on the model comprises performing a causal analysis of a plurality of equations associated with the model.

18. The computer system of claim 16, wherein performing the causal analysis comprises generating a block lower triangular (BLT) form of the plurality of equations.

19. The computer system of claim 14, wherein decomposing the model into multiple independent subsystem models comprises identifying, for each subsystem model, a number of input variables.

20. The computer system of claim 18, wherein the method further comprises:
obtaining sensor measurement results associated with the identified input variables; and
using the sensor measurement results as inputs of the subsystem model during the fault-diagnosis operation.
